(19) United States
(12) Patent Application Publication
(10) Pub. No.: US 2013/0081269 A1
(43) Pub. Date: Apr. 4, 2013

(54) SYSTEMS AND METHODS FOR REPAIRING HOLES

(71) Applicants: Timothy Joseph Trapp, Wyoming, OH (US); Seth Carl Shira, Cardington, OH (US); Jeffrey James Root, Columbus, OH (US)

(72) Inventors: Timothy Joseph Trapp, Wyoming, OH (US); Seth Carl Shira, Cardington, OH (US); Jeffrey James Root, Columbus, OH (US)

(21) Appl. No.: 13/249,440

(22) Filed: Sep. 30, 2011

(51) Int. Cl. B23P 6/00; B22D 31/00

(52) U.S. Cl. 29/888; 29/33 A

(57) ABSTRACT

A system for repairing holes in a turbine engine component is provided. The system includes a turbine engine component including a front surface, a back surface, and a tapered surface extending from the front surface to the back surface, the tapered surface circumscribing the hole. The system further includes a plug configured to be welded to the turbine engine component, the plug including at least one tapered portion configured to contact the tapered surface when the plug is welded to the turbine engine component, and a die plate positioned on the back surface of the turbine engine component and including an aperture defined therethrough that is configured to collect flash generated when the plug is welded to the turbine engine component.

### BACKGROUND OF THE INVENTION

This invention relates generally to gas turbine engines, and more particularly, to repairing holes in gas turbine engines.

Gas turbine engines typically include an engine casing that extends circumferentially around a compressor, and a turbine including a rotor assembly and a stator assembly. The rotor assembly includes at least one row of rotating blades that extend radially outward from a blade root to a blade tip.

One or more components in known gas turbine engines may include holes defined therein. These holes may be defined in static components (e.g., a casing) and/or rotating components (e.g., rotor blades). Further, different holes may serve different functions. For example, a gas turbine engine may include holes for receiving fasteners, cooling holes, and/or fluid inlet holes. Such holes are initially formed at specific positions with particular dimensions. However, over time, holes in one or more components in a gas turbine engine may degrade. Specifically, holes may become deformed, corroded, worn, and/or elongated. As the degradation will alter the position and characteristics of the hole, the degradation may hinder operation of the gas turbine engine.

In at least some known methods, when a hole becomes degraded, the engine component containing the hole is replaced. Replacing entire components to replace a hole may be relatively expensive and time-consuming Accordingly, in at least some methods, degraded holes are repaired without replacing the entire engine component. However, in at least some known methods, repairing the hole may result in imperfections in the engine component, and/or the repaired hole may not be substantially similar to the original hole. Moreover, at least some known methods utilize consumable plates above and below the component to be repaired, increasing the cost and complexity of the repair process.

### BRIEF DESCRIPTION OF THE INVENTION

In one aspect, a system for repairing a hole is provided. The system includes a turbine engine component including a front surface, a back surface, and a tapered surface extending from the front surface to the back surface, the tapered surface circumscribing the hole. The system further includes a plug configured to be welded to the turbine engine component, the plug including at least one tapered portion configured to contact the tapered surface when the plug is welded to the turbine engine component, and a die plate positioned on the back surface of the turbine engine component and including an aperture defined therethrough that is configured to collect flash generated when the plug is welded to the turbine engine component.

In another aspect, a method for repairing a hole in a turbine engine component is provided. The method includes machining the turbine engine component such that the hole is circumscribed by a tapered surface extending from a front surface of the turbine engine component to a back surface of the turbine engine component, positioning a die plate on the back surface of the turbine engine component, and welding a plug including at least one tapered portion to the engine component, wherein the at least one tapered portion of the plug contacts the tapered surface during the welding.

In yet another aspect, a method for repairing a hole in a turbine engine component is provided. The method includes positioning a die plate on a back surface of the turbine engine component, coupling a plug to a spindle, the plug including at least one tapered portion, accelerating the plug to a predetermined rotational speed using the spindle, putting the rotating plug into contact with the turbine engine component such that the at least one tapered portion contacts a tapered surface of the turbine engine component, the tapered surface circumscribing the hole, and forming a weld between the at least one tapered portion and the tapered surface.

### BRIEF DESCRIPTION OF THE DRAWINGS

FIG. 1 is a schematic illustration of an exemplary gas turbine engine.

FIG. 2 is a cross-sectional view of an exemplary system for repairing holes that may be used with the gas turbine engine shown in FIG. 1.

FIG. 3 is a flowchart of an exemplary method for repairing holes that may be used with the gas turbine engine shown in FIG. 1.

### DETAILED DESCRIPTION OF THE INVENTION

The systems and methods described herein facilitate repairing holes in a turbine engine component. To repair a hole, a plug having at least one tapered portion is welded to a tapered surface in the turbine engine component. A die plate positioned on a back surface of the turbine engine component collects the flash generated during the welding process. Once the plug is welded to the turbine engine component, excess material can be removed, and a new hole may be drilled in the turbine engine component.

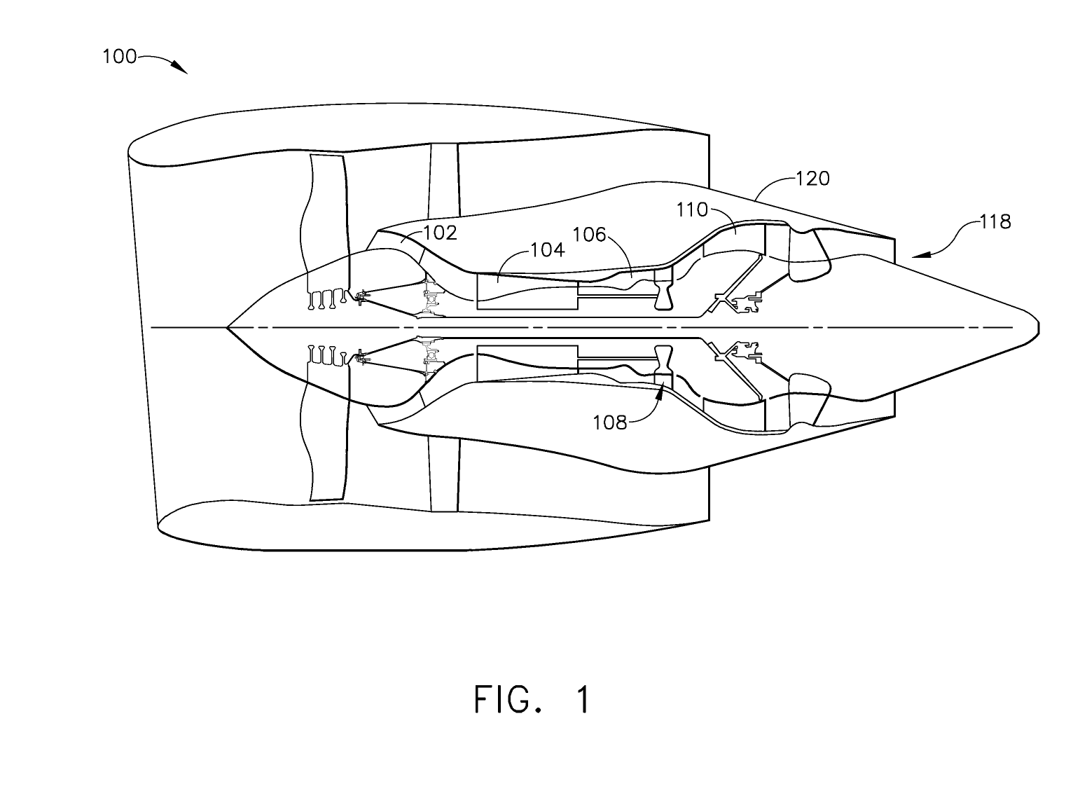

FIG. 1 is a schematic illustration of a gas turbine engine 100 including a fan assembly 102, a high pressure compressor 104, and a combustor 106. Engine 100 also includes a high pressure turbine 108 and a low pressure turbine 110. In operation, air flows through fan assembly 102 and compressed air is supplied from fan assembly 102 to high pressure compressor 104. The highly compressed air is delivered to combustor 106. Airflow from combustor 106 drives rotating turbines 108 and 110 and exits gas turbine engine 100 through an exhaust system 118.

In the exemplary embodiment, gas turbine engine 100 is a gas turbine engine 100 of an aircraft (not shown). Alternatively, gas turbine engine 100 may be used with any other machine, system, or device. Gas turbine engine 100 may include one or more electronic controls. Components of gas turbine engine 100 are at least partially enclosed by an engine casing 120. In the exemplary embodiment, engine casing 120 is manufactured from aluminum, an aluminum alloy, and/or any other material that enables casing 120 to function as described herein.

In the exemplary embodiment, turbine engine 100 includes a plurality of holes. For example, casing 120 may include several holes. These holes may be defined in static components (e.g., casing 120) and/or rotating components (e.g., rotor blades in fan assembly 102). Further, different holes may serve different functions. For example, gas turbine engine 100 may include holes for receiving fasteners, cooling holes, and/or fluid inlet holes. Such holes are initially formed at specific positions with particular dimensions. Over time, these holes may become deformed, corroded, worn and/or elongated. Accordingly, to ensure proper operation of gas turbine engine 100, deformed, corroded, worn, and/or elongated holes may be repaired, as described herein.

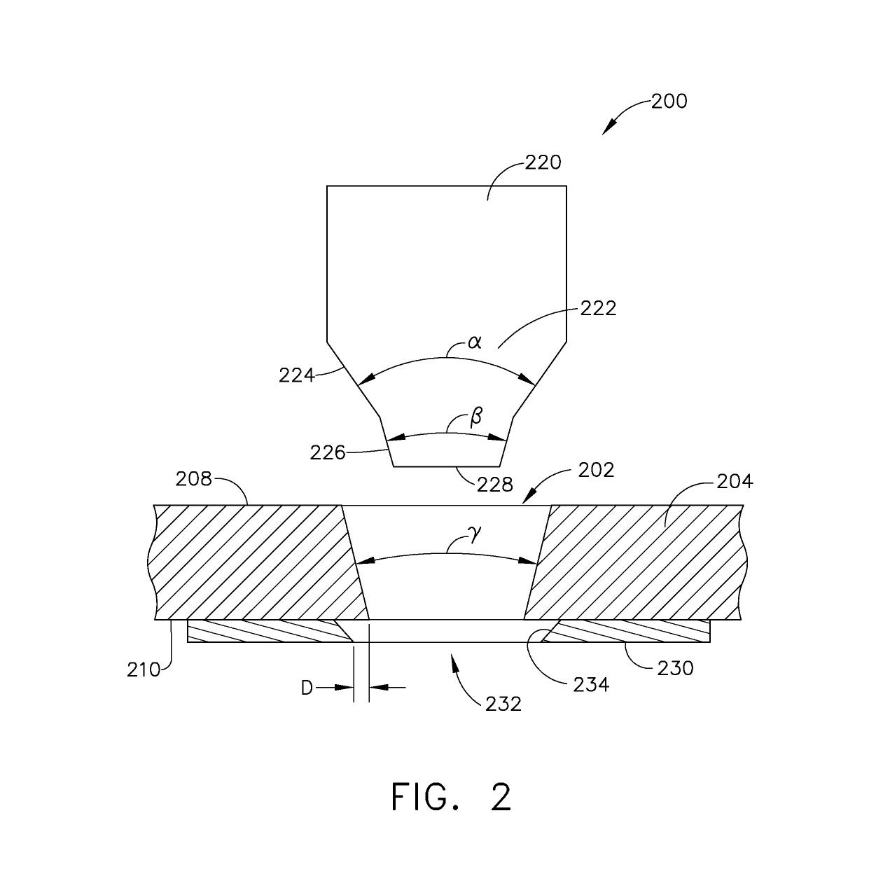

FIG. 2 is a cross-sectional view of an exemplary system 200 for repairing a hole 202 in a turbine engine, such as turbine engine 100 (shown in FIG. 1). In the exemplary embodiment, hole 202 is formed in a casing 204, such as casing 120 (shown in FIG. 1). Alternatively, hole 202 is formed in any component that enables system 200 to function as described herein. To facilitate repair, hole 202 is machined to have a tapered surface 206. Any known method of machining can be used to form tapered surface 206. Tapered surface 206 extends from a front surface 208 to a back surface 210 of casing 204.

System 200 includes a consumable plug 220 that is substantially cylindrical. Plug 220 is manufactured from aluminum, an aluminum alloy, and/or any other material that enables plug 220 to function as described herein. In the exemplary embodiment, plug 220 is manufactured from the same material as casing 204. Alternatively, plug 220 is manufactured from a different material than casing 204. For example, plug 220 may be manufactured from a magnesium, aluminum, titanium, nickel, iron, and/or cobalt alloy.

Plug 220 includes a tapered tip 222 that has a frusto-conical shape. In the exemplary embodiment, tip 222 includes a first tapered portion 224 that tapers at a first taper angle, α, and a second tapered portion 226 that tapers at a second taper angle, β. Any known method of machining can be used to form first tapered portion 224 and second tapered portion 226. Second tapered portion 226 terminates at a substantially planar tip surface 228.

In the exemplary embodiment, the second taper angle β matches a third taper angle, γ, of tapered surface 206. Moreover, the first taper angle α is different from the second taper angle β in the exemplary embodiment. Specifically, the first taper angle α is less than the second taper angle β. For example, in one embodiment, the first taper angle α is approximately 58°, and the second taper angle β is approximately 60°. Alternatively, first taper angle α and second taper angle β may have any taper angle that enables system 200 to function as described herein. Moreover, in some embodiments, plug 220 may have only one tapered portion that is uniformly tapered.

A non-consumable die plate 230 is positioned on back surface 210 of casing 204. In the exemplary embodiment, non-consumable die plate 230 includes a funnel-shaped aperture 232 defined by a die plate surface 234. In the exemplary embodiment, die plate surface 234 is chamfered. Alternatively, die plate surface 234 may be arcuate or substantially orthogonal to back surface 210 of component 204. Die plate 230 may be manufactured from steel, tungsten, and/or any other material (e.g., a metal and/or ceramic material) which enables die plate 230 to function as described herein. For example, when casing 204 is manufactured from aluminum, die plate 230 may be manufactured from steel. When casing 204 is manufactured from a harder metal (e.g., an iron and/or nickel alloy), die plate 230 may be manufactured from a tungsten-lanthanum alloy.

Aperture 232 facilitates collecting plasticized material from plug 220 during the welding process, as described in detail below. In the exemplary embodiment, die plate 230 is positioned on back surface 210 such that aperture 232 is aligned with hole 202. Aperture 232 has a diameter that is greater than or equal to the diameter of hole 202. For example, in the exemplary embodiment, die plate surface 234 is offset a distance, D, from tapered surface 206. In the exemplary embodiment, D is approximately 0.010 to 0.050 inches. Alternatively, D is any distance that enables die plate 230 to function as described herein.

In the exemplary embodiment, plug 220 is inertia welded to casing 204 to repair hole 202. That is, plug 220 is coupled to a rotating spindle and flywheel (neither shown) and accelerated to a predetermined rotational speed. Once plug 220 is rotating at the predetermined speed, plug 220 is inserted into hole 202 such that first tapered portion 224 and second tapered portion 226 contact tapered surface 206. Once plug 220 contacts casing 204, the rotational speed of plug 220 begins to decrease, and the potential energy stored in the flywheel is transforms into heat energy that welds plug 220 to casing 204. Because first taper angle α is less than the second taper angle β, second tapered portion 226 contacts tapered surface 206 before first tapered portion 224. This facilitates generating more heat at the beginning of the inertia welding process, which may improve the weld formed between plug 220 and casing 204.

The frictional contact causes first and second tapered portions 224 and 226 and tapered surface 206 to plasticize as plug 220 slows down relative to casing 204, forming a weld between first and second tapered portions 224 and 226 and tapered surface 206. While in the exemplary embodiment, inertia welding is used to weld plug 220 to casing 204, alternatively, any suitable welding technique (e.g., friction welding) may be utilized to weld plug 220 to casing 204. During the inertia welding, flash generated by the plasticization of first and second tapered portions 224 and 226 and tapered surface 206 flows through and collects in aperture 232 of die plate 230. Specifically, as aperture 232 has a diameter at least as large as the diameter of hole 202, material generated at the interface between first and second tapered portions 224 and 226 and tapered surface 206 is extruded into aperture 232. This facilitates producing a substantially defect-free weld, as it prevents contaminants from becoming trapped in the weld.

As the inertia welding process is a solid state process, no melting occurs between the plug 220 and casing 204. Instead, the plug 220 and casing 204 heat and soften to bind to one another. Moreover, flash generated during the welding removes contaminants from first and second tapered portions 224 and 226 and tapered surface 206.

Once plug 220 is welded to casing 204, plug 220 substantially fills hole 202, forming a repaired zone. Excess material generated during the welding process may be removed using any known methods. For example, portions of the plug 220 above the front surface 208 and/or below the back surface 210 may be removed. In the exemplary embodiment, in which plug 220 is manufactured from the same material, the welded plug 220 and casing 204 combination is substantially uniform, and in substantially the same condition as casing 204 before hole 202 was formed in casing 204. That is, the welded plug 220 and casing 204 combination have a substantially equivalent mechanical performance to the original state of casing 204.

A new hole (not shown) having dimensions of the original hole is drilled through the welded plug 220 and casing 204 combination. The new hole may be formed using any known method of machining. The new hole is free of deformation, corrosion, wear, and/or elongation, and accordingly, replaces the deformed, corroded, worn, and/or elongated hole in casing 204.

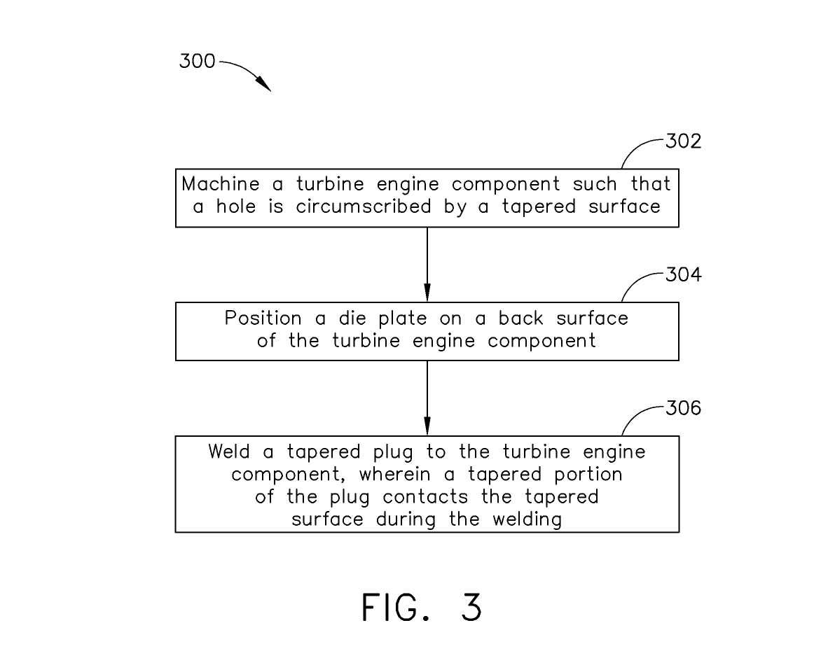

FIG. 3 is a flowchart of an exemplary method 300 for repairing a hole, such as hole 202. Method 300 includes machining 302 a turbine engine component, such as casing 204. The turbine engine component is machined such that the hole is circumscribed by a tapered surface, such as tapered surface 206. The tapered surface extends from a front surface of the turbine engine component to a back surface of the turbine engine component, such as front and back surfaces 208 and 210.

A die plate, such as die plate 230 is positioned 304 on the back surface of the turbine engine component. A plug, such as plug 220 is welded 306 to the turbine engine component. The plug 220 includes at least one tapered portion, such as first tapered portion 224 and second tapered portion 226. Plug 220 is welded 306 to the turbine engine component such that the at least one tapered portion of the plug contacts the tapered surface of the turbine engine component.

The methods and systems described herein enable repairing deformed, corroded, worn, and/or elongated holes in a turbine engine. Accordingly, the methods and systems described herein facilitate increasing the longevity of the turbine engine and efficiently repairing the turbine engine. The methods and systems described herein further facilitate maintaining a turbine engine without having to replace entire components of the turbine engine.

Exemplary embodiments of methods and systems for repairing holes are described above in detail. The methods and systems for repairing holes are not limited to the specific embodiments described herein, but rather, components of the methods and systems may be utilized independently and separately from other components described herein. For example, the methods and systems described herein may be used to repair components other than turbine engine components. Accordingly, the present invention can be implemented and utilized in connection with many other industries.

While the invention has been described in terms of various specific embodiments, those skilled in the art will recognize that the invention can be practiced with modification within the spirit and scope of the claims.

What is claimed is:

1. A system for repairing a hole comprising:
a turbine engine component comprising:
a front surface;
a back surface; and
a tapered surface extending from said front surface to said back surface, said tapered surface circumscribing the hole;
a plug configured to be welded to said turbine engine component, said plug comprising at least one tapered portion configured to contact said tapered surface when said plug is welded to said turbine engine component; and
a die plate positioned on said back surface of said turbine engine component and having an aperture defined therethrough that is configured to collect flash generated when said plug is welded to said turbine engine component.

2. A system in accordance with claim 1, wherein said plug is configured to be inertia welded to said turbine engine component.

3. A system in accordance with claim 1, wherein said at least one tapered portion comprises a first tapered portion having a first taper angle and a second tapered portion having a second taper angle.

4. A system in accordance with claim 3, wherein said first taper angle is less than said second taper angle.

5. A system in accordance with claim 4, wherein said second taper angle matches a taper angle of said tapered surface.

6. A system in accordance with claim 1, wherein said die plate comprises a chamfered surface circumscribing the die plate aperture.

7. A system in accordance with claim 1, wherein the die plate aperture has a diameter at least as large as a diameter of the hole.

8. A method for repairing a hole in a turbine engine component, the method comprising:
machining the turbine engine component such that the hole is circumscribed by a tapered surface extending from a front surface of the turbine engine component to a back surface of the turbine engine component;
positioning a die plate on the back surface of the turbine engine component; and
welding a plug including at least one tapered portion to the engine component, wherein the at least one tapered portion of the plug contacts the tapered surface during the welding.

9. A method in accordance with claim 8, wherein welding a plug comprises inertia welding a plug to the engine component.

10. A method in accordance with claim 8, wherein positioning a die plate comprises positioning a die plate having an aperture defined therethrough, the aperture having a diameter at least as large as a diameter of the hole.

11. A method in accordance with claim 8, further comprising removing excess material from the plug and the turbine engine component that is generated when welding the plug to the turbine engine component.

12. A method in accordance with claim 8, further comprising drilling a replacement hole through the welded plug and turbine engine component.

13. A method in accordance with claim 8 wherein welding a plug comprises welding a plug including a first tapered portion and a second tapered portion.

14. A method in accordance with claim 8, wherein positioning a die plate comprises positioning a die plate having a funnel-shaped aperture defined therethrough that is configured to collect flash produce when the plug is welded to the engine component.

15. A method in accordance with claim 8, wherein positioning a die plate comprises positioning a die plate having an aperture defined therethrough that is aligned with the hole.

16. A method for repairing a hole in a turbine engine component, the method comprising:
positioning a die plate on a back surface of the turbine engine component;
coupling a plug to a spindle, the plug including at least one tapered portion;
accelerating the plug to a predetermined rotational speed using the spindle;
putting the rotating plug into contact with the turbine engine component such that the at least one tapered portion contacts a tapered surface of the turbine engine component, the tapered surface circumscribing the hole; and
forming a weld between the at least one tapered portion and the tapered surface.

17. A method in accordance with claim 16, wherein coupling a plug comprises coupling a plug including a first tapered portion having a first taper angle and a second tapered portion having a second taper angle, the first taper angle less than the second taper angle.

18. A method in accordance with claim 16, wherein positioning a die plate comprises positioning a die plate having an aperture defined therethrough, the aperture having a diameter at least as large as a diameter of the hole.

19. A method in accordance with claim 16, wherein positioning a die plate comprises positioning a die plate having a funnel-shaped aperture defined therethrough that is configured to collect flash generated when the weld is formed between the at least one tapered portion and the tapered surface.

20. A method in accordance with claim 16, further comprising drilling a replacement hole through the welded plug and turbine engine component.
